(19) United States
(12) Patent Application Publication
(10) Pub. No.: US 2015/0095192 A1
(43) Pub. Date: Apr. 2, 2015

(54) UTILIZING AN IMAGE FOR FACILITATING AN EBOOK TRANSACTION

(71) Applicant: KOBO INCORPORATED, Toronto (CA)

(72) Inventors: Damian Lewis, Toronto (CA); Ryan Sood, Toronto (CA)

(21) Appl. No.: 14/042,407

(22) Filed: Sep. 30, 2013

(51) Int. Cl. G06Q 30/06

(52) U.S. Cl. CPC G06Q 30/0623; G06Q 30/0643
USPC 705/26.61

(57) ABSTRACT

A method and system for utilizing an image for facilitating an eBook transaction is disclosed. One example captures a digital image of a portion of a book with a digital camera of an electronic personal display. The electronic personal display determines a unique identification of the book from the digital image. The electronic personal display outputs an offer to sell an eBook version of the book. The electronic personal display inputs an acceptance to purchase the eBook and provides the eBook in an e-library.

### BACKGROUND

An electronic reader, also known as an eReader, is an electronic personal display that is used for reading electronic books (eBooks), electronic magazines, and other digital content. For example, digital content of an eBook is displayed as alphanumeric characters and/or graphic images on a display of an eReader such that a user may read the digital content much in the same way as reading the analog content of a printed page in a paper-based book. An eReader provides a convenient format to store, transport, and view a large collection of digital content that would otherwise potentially take up a large volume of space in traditional paper format.

In some instances, eReaders are purpose built devices designed to perform especially well at displaying alphanumeric digital content (e.g., text). For example, a purpose built eReader may include a display that reduces glare, performs well in high light conditions, and/or mimics the look of printed text on actual paper. While such purpose built eReaders may excel at displaying alphanumeric digital content for a user to read, they may also perform other functions, such as displaying graphic images, emitting audio, capturing audio, capturing digital images, and web surfing, among others.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1A shows a book cover in accordance with various embodiments.

FIG. 1B shows a page of a book in accordance with various embodiments.

FIG. 1C shows a matrix barcode in accordance with various embodiments.

FIG. 1D shows a barcode in accordance with various embodiments.

FIG. 1E shows an international standard book number (ISBN) in accordance with various embodiments.

FIG. 1F shows a uniform resource locator (URL) in accordance with various embodiments.

FIG. 2 shows an eBook transaction system, in accordance with various embodiments.

FIG. 3 illustrates a flow diagram of a method for utilizing an image for facilitating an eBook transaction at the purchaser side, according to various embodiments.

FIG. 4 illustrates a flow diagram of a method for utilizing an image for facilitating an eBook transaction at the server side, according to various embodiments.

FIG. 5 shows an example computing system which may be included as a component of an eReader, according to various embodiments.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “capturing”, “determining”, “outputting”, “inputting”, “providing”, “receiving”, “utilizing” or the like, often refer to the actions and processes of an electronic computing device/system, such as a mobile phone, an electronic personal display, and/or a mobile (i.e., handheld) multimedia device, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

### Overview of Discussion

In the following discussion an image capture for facilitating an eBook transaction is disclosed. In one embodiment, a book, an eReader, a tablet or the like is open in front of a user. For example, one person is showing another person a book they are reading. In another embodiment, the book may be a library book, or a book found on a shelf If the user is interested in getting their own eBook copy of the book, the user takes a picture of the cover, a page, or another part of the book. Utilizing the methods described herein, the picture is analyzed to identify the book and the user is presented with the opportunity to buy the book and add it to their e-library.

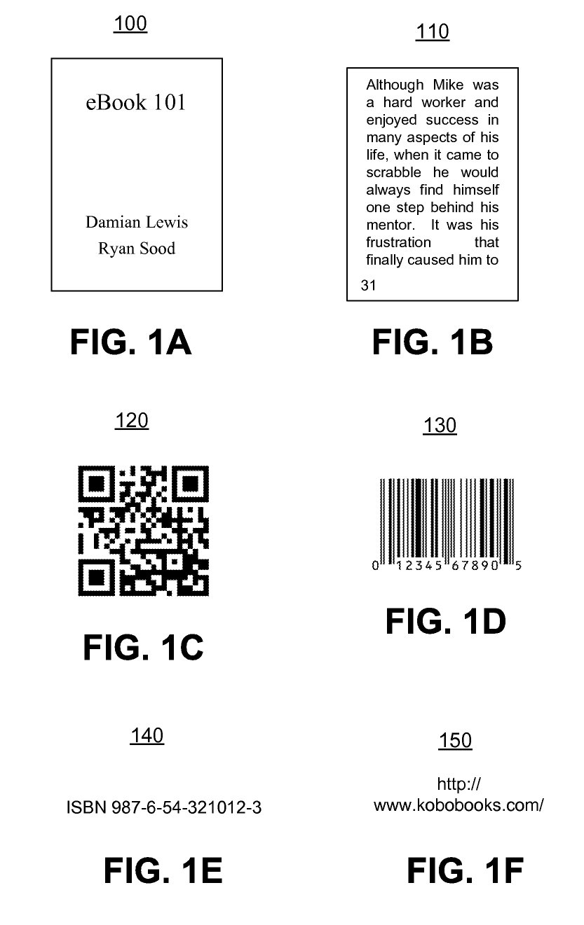

With reference now to FIGS. 1A-1F, a number of different images are shown. In general, the images of FIGS. 1A-1F are a few of the many possible images that may be taken of a book. FIG. 1A shows a book cover 100 in accordance with various embodiments. FIG. 1B shows a page (or portion of a page) 110 in accordance with various embodiments. FIG. 1C shows a matrix barcode 120 in accordance with various embodiments. FIG. 1D shows a barcode such as a universal product code (UPC) 130 in accordance with various embodiments. FIG. 1E shows an international standard book number (ISBN) 140 in accordance with various embodiments. FIG. 1F shows a uniform resource locator (URL) 150 in accordance with various embodiments.

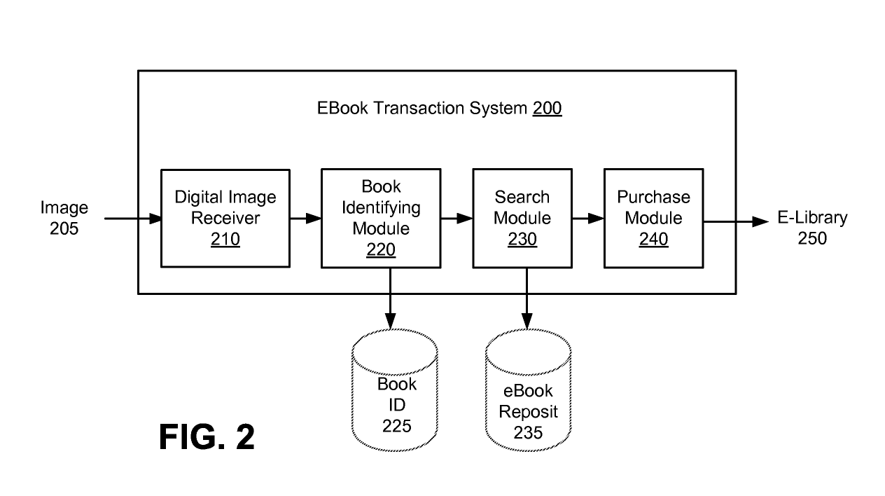

Referring now to FIG. 2, an eBook transaction system 200 is shown, in accordance with various embodiments. In one embodiment, eBook transaction system 200 includes a digital image receiver 210, a book identifying module 220, a search module 230 and a purchase module 240. In one embodiment, the components of eBook transaction system 200 may be located in a single device. In another embodiment, one or more of the components of eBook transaction system 200 may be found in different locations and/or on different devices.

In general, digital image receiver 210 receives a digital image 205 of a portion of a book. As shown in FIGS. 1A-1F, digital image 205 is an image of a portion of a paper book or an electronic book. Moreover, digital image 205 may be a complete page or a portion of a page.

In general, digital image 205 could be, but is not limited to, a cover 100, a page 110, a matrix barcode 120, a UPC 130, an ISBN 140, a URL 150 or the like. In addition, the digital image may include more than one of the above stated identifiers. In one embodiment, digital image receiver 210 will perform an optical character recognition (OCR) on digital image 205.

Book identifying module 220 determines a unique identification of the book. In other words, book identifying module 220 is a search module that searches for a book that correlates with the information extracted from digital image 205. For example, book identifying module 220 receives the image information from digital image receiver 210 and accesses a book identity database 225. In general, book identity database 225 is a database of information about a plurality of different books. For example, book identity database 225 may include a number of books, each of the books including identifying information, such as, an electronic copy of the book, the title of the book, the ISBN, the Author of the book and the like. In one embodiment, book identity database 225 may be a single server, but in another embodiment, book identity database 225 may be a vast array of servers accessible via the Internet. In general, book identifying module 220 provides unique book identification information for the book of digital image 205.

Search module 230 receives the unique book identification information from book identifying module 220 and performs a search for an eBook version of the identified book. In one embodiment, search module 230 accesses an eBook repository 235. In one embodiment, eBook repository 235 may be a single server, but in another embodiment, eBook repository 235 may be a vast array of servers accessible via the Internet. In general, eBook repository 235 may be a database of any number of available eBooks.

Purchase module 240 receives information from search module 230 that may include eBook price, availability, size, and the like. Purchase module 240 allows a user to purchase the identified eBook. When the eBook is purchased, purchase module 240 will add the eBook to the buyer's e-library 250.

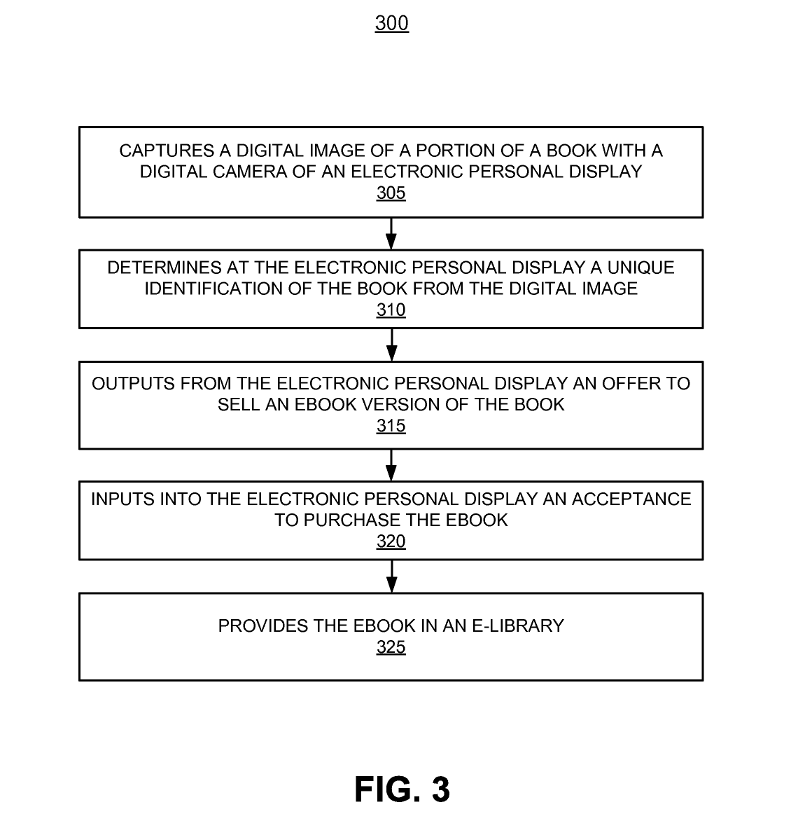

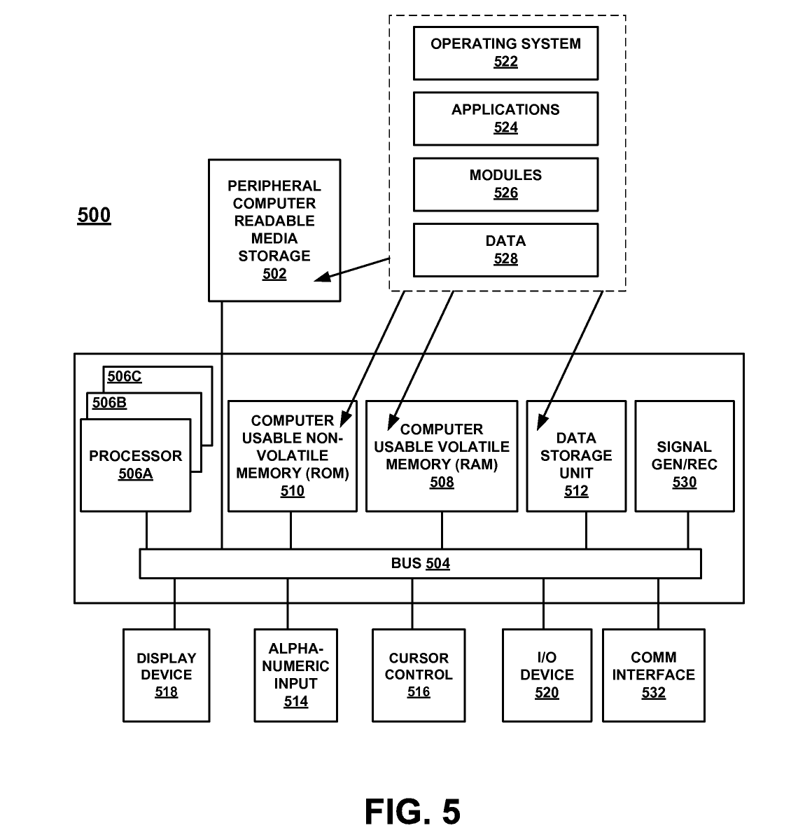

With reference now to FIG. 3, a flow diagram 300 of a method for facilitating an eBook transaction at the purchaser side is shown according to various embodiments. In one embodiment, flowchart 400 may be performed by an electronic personal display, such as a phone, tablet, electronic reader (eReader), or the like that includes a camera capable of taking digital image 205. An example system of the electronic personal display is described in FIG. 5.

With reference now to 305 of FIG. 3 and to FIG. 1A-1F, one embodiment captures a digital image of a portion of a book with a digital camera of an electronic personal display. For example, a digital camera may be used to capture digital image 205. In one embodiment, digital image 205 is an image of a portion of a hard copy of the book. In another embodiment, digital image 205 is an image of a portion of an electronic copy of the book. In one embodiment, as shown in FIGS. 1A-1F, the portion of the book in digital image 205 may be, but is not limited to, cover 100, page 110, matrix barcode 120, UPC 130, ISBN 140, URL 150 or the like. In addition, the digital image may include more than one of the above stated identifiers.

Referring now to 310 of FIG. 3 and to FIG. 2, one embodiment determines at the electronic personal display a unique identification of the book from the digital image. For example, if the digital image is a page of text such as cover 100 or page 110, optical character recognition (OCR) may be performed on the digital image to define a section of text. In one embodiment, the section of text may include a title or an author. The text would then be compared with text in book identifying database 225 by book identifying module 220.

One embodiment will utilize the unique identification of the book to search for an eBook version. For example, search module 230 would receive the unique identification information from book identifying module 220. Search module 230 would then access one or more repositories such as eBook repository 235 to determine if the eBook is available.

With reference now to 315 of FIG. 3 and to FIG. 1A-1F, one embodiment outputs from the electronic personal display an offer to sell an eBook version of the book. For example, after search module 230 determines that the eBook is available from an eBook repository 235, the availability and price of the eBook are provided to purchase module 240. In one embodiment, purchase module 240 will then provide notice that the eBook is available for purchase.

Referring now to 320 of FIG. 3 and to FIG. 2, one embodiment inputs into the electronic personal display an acceptance to purchase the eBook. For example, after providing the availability and purchase price, purchase module 240 will receive authorization to purchase the eBook. In another embodiment, instead of providing notice that the eBook is available for purchase, purchase module 240 may access a user account related to the provider of image 205 and automatically purchase the eBook.

With reference now to 325 of FIG. 3 and to FIG. 2, one embodiment provides the eBook in an e-library. One embodiment provides the eBook to a buyer's e-library 250. In another embodiment, the eBook may be downloaded directly to the user's eReader.

For example, in operation, a user snaps digital image 205 of a paper book portion (an open page; the book front cover; or ISBN) using a mobile device. The digital image 205 may be digital, or digitized via optical character recognition to uniquely identify the book via a cloud repository of book titles such as book identity database 225. Once the book is uniquely identified the user is presented with an offer to buy that e-book for inclusion within the user's e-library 250 associated with that user's account. In another example, if the user already has the e-book version within their e-library 250, the e-book version could be bookmarked, such as for reading while on a trip where carrying the paper version would be inconvenient. In yet another example, if the e-book version is not stored locally at the user's reading device, then it may be automatically downloaded from user's e-library 250 in the cloud repository.

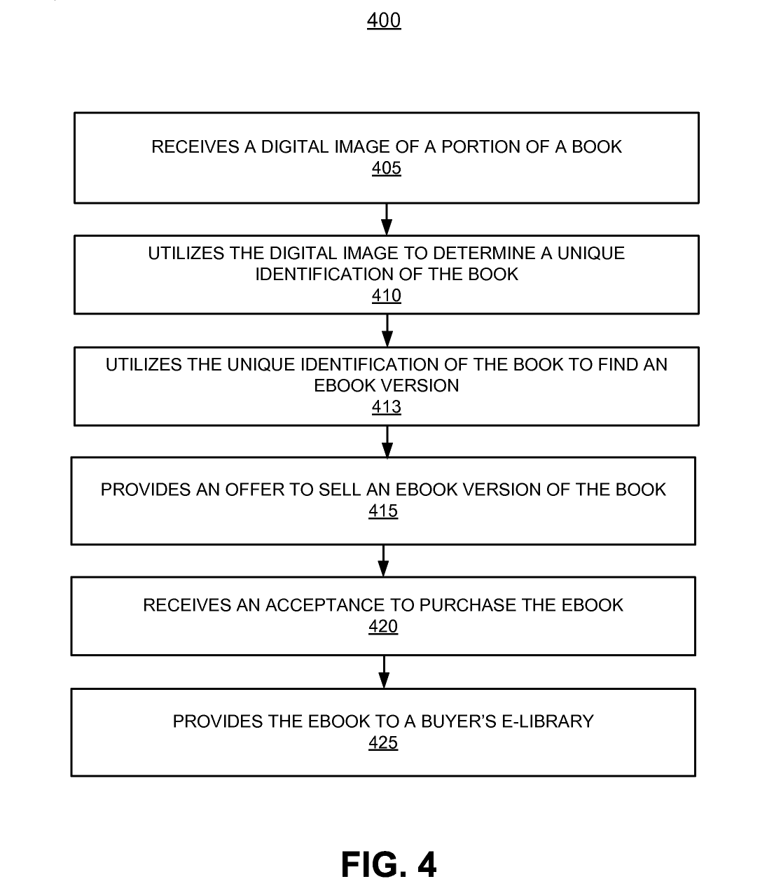

Referring now to FIG. 4, a flow diagram 400 of a method for facilitating an eBook transaction at the server side is shown in accordance with one embodiment. In one embodiment, flowchart 400 may be performed by a server on the cloud or internet connection.

With reference now to 405 of FIG. 4, one embodiment receives a digital image of a portion of a book. In one embodiment, the digital image is an image of a portion of a hard copy of the book. In another embodiment, the digital image is an image of a portion of an electronic copy of the book. In one embodiment, as shown in FIGS. 1A-1F, the portion of the book may be, but is not limited to, a cover 100, a page 110, an international standard book number (ISBN) 140, a barcode 130, a matrix barcode 120, a universal product code (UPC), a uniform resource locator (URL) 150 or the like. In addition, the digital image may include more than one of the above stated identifiers.

Referring now to 410 of FIG. 4 and FIGS. 1A-1F, one embodiment utilizes the digital image to determine a unique identification of the book. For example, if the digital image is a page of text such as cover 100 or page 110, optical character recognition (OCR) may be performed on the digital image to define a section of text. In one embodiment, the section of text may include a title or an author. The text would then be compared with text in book identity database 225 by book identifying module 220.

With reference now to 413 of FIG. 4 and FIG. 2, one embodiment utilizes the unique identification of the book to find an eBook version. For example, search module 230 would receive the unique identification information from book identifying module 220. Search module 230 would then access one or more repositories such as eBook repository 235 to determine if the eBook is available.

Referring now to 415 of FIG. 4 and FIGS. 1A-1F, one embodiment provides an offer to sell an eBook version of the book. For example, after search module 230 determines that the eBook is available from an eBook repository 235, the availability and price of the eBook are provided to purchase module 240. In one embodiment, purchase module 240 will then provide notice that the eBook is available for purchase.

With reference now to 420 of FIG. 4 and FIGS. 1A-1F, one embodiment receives an acceptance to purchase the eBook. For example, after providing the availability and purchase price, purchase module 240 will receive authorization to purchase the eBook. In another embodiment, instead of providing notice that the eBook is available for purchase, purchase module 240 may access a user account related to the provider of image 205 and automatically purchase the eBook.

Referring now to 425 of FIG. 4 and FIGS. 1A-1F, one embodiment provides the eBook to a buyer's e-library 250. In another embodiment, the eBook may be downloaded directly to the user's eReader.

### Example Computer System Environment

With reference now to FIG. 5, portions of the technology for providing a communication composed of computer-readable and computer-executable instructions that reside, for example, in non-transitory computer-usable storage media of a computer system. That is, FIG. 5 illustrates one example of a type of computer that can be used to implement embodiments of the present technology. FIG. 5 represents a system or components that may be used in conjunction with aspects of the present technology. In one embodiment, some or all of the components of FIG. 1A-1F or FIG. 3 may be combined with some or all of the components of FIG. 5 to practice the present technology.

FIG. 5 illustrates an example computer system 500 used in accordance with embodiments of the present technology. It is appreciated that system 500 of FIG. 5 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 5, computer system 500 of FIG. 5 is well adapted to having peripheral computer readable media 502 such as, for example, a floppy disk, a compact disc, a flash drive, and the like coupled thereto.

System 500 of FIG. 5 includes an address/data/control bus 504 for communicating information, and a processor 506A coupled to bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. System 500 also includes data storage features such as a computer usable volatile memory 508, e.g. random access memory (RAM), coupled to bus 504 for storing information and instructions for processors 506A, 506B, and 506C.

System 500 also includes computer usable non-volatile memory 510, e.g. read only memory (ROM), coupled to bus 504 for storing static information and instructions for processors 506A, 506B, and 506C. Also present in system 500 is a data storage unit 512 (e.g., a magnetic or optical disk and disk drive) coupled to bus 504 for storing information and instructions. System 500 also includes an optional alpha-numeric input device 514 including alphanumeric and function keys coupled to bus 504 for communicating information and command selections to processor 506A or processors 506A, 506B, and 506C. System 500 also includes an optional cursor control device 516 coupled to bus 504 for communicating user input information and command selections to processor 506A or processors 506A, 506B, and 506C. System 500 of the present embodiment also includes an optional display device 518 coupled to bus 504 for displaying information.

Referring still to FIG. 5, optional display device 518 of FIG. 5 may be a liquid crystal device, cathode ray tube, OLED, plasma display device or other display device suitable for creating graphic images and alpha-numeric characters recognizable to a user. Optional cursor control device 516 allows the computer user to dynamically signal the movement of a visible symbol (cursor) on a display screen of display device 518. Many implementations of cursor control device 516 are known in the art including a trackball, mouse, touch pad, joystick or special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands.

System 500 is also well suited to having a cursor directed by other means such as, for example, voice commands. System 500 also includes an I/O device 520 for coupling system 500 with external entities. For example, in one embodiment, I/O device 520 is a modem for enabling wired or wireless communications between system 500 and an external network such as, but not limited to, the Internet or intranet. A more detailed discussion of the present technology is found below.

Referring still to FIG. 5, various other components are depicted for system 500. Specifically, when present, an operating system 522, applications 524, modules 526, and data 528 are shown as typically residing in one or some combination of computer usable volatile memory 508, e.g. random access memory (RAM), and data storage unit 512. However, it is appreciated that in some embodiments, operating system 522 may be stored in other locations such as on a network or on a flash drive; and that further, operating system 522 may be accessed from a remote location via, for example, a coupling to the internet. In one embodiment, the present technology, for example, is stored as an application 524 or module 526 in memory locations within RAM 508 and memory areas within data storage unit 512. The present technology may be applied to one or more elements of described system 500.

System 500 also includes one or more signal generating and receiving device(s) 530 coupled with bus 504 for enabling system 500 to interface with other electronic devices and computer systems. Signal generating and receiving device(s) 530 of the present embodiment may include wired serial adaptors, modems, and network adaptors, wireless modems, and wireless network adaptors, and other such communication technology. The signal generating and receiving device(s) 530 may work in conjunction with one or more communication interface(s) 532 for coupling information to and/or from system 500. Communication interface 532 may include a serial port, parallel port, Universal Serial Bus (USB), Ethernet port, Bluetooth, thunderbolt, near field communications port, WiFi, Cellular modem, or other input/output interface. Communication interface 532 may physically, electrically, optically, or wirelessly (e.g. via radio frequency) couple system 500 with another device, such as a cellular telephone, radio, or computer system.

The computing system 500 is only one example of a suitable computing environment and is not intended to suggest any limitation as to the scope of use or functionality of the present technology. Neither should the computing environment 500 be interpreted as having any dependency or requirement relating to any one or combination of components illustrated in the example computing system 500.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A computer implemented method for utilizing an image for facilitating an eBook transaction, said method comprising:
capturing a digital image of a portion of a book with a digital camera of an electronic personal display;
determining at the electronic personal display a unique identification of the book from the digital image;
outputting from the electronic personal display an offer to sell an eBook version of the book;
inputting into the electronic personal display an acceptance to purchase the eBook; and
providing the eBook in an e-library.

2. The method of claim 1 further comprising:
automatically downloading the eBook from the e-library in a cloud repository to a local storage of an electronic reader (eReader).

3. The method of claim 1 further comprising:
capturing a digital image of a portion of a hard copy book.

4. The method of claim 1 further comprising:
capturing a digital image of a portion of an electronic book.

5. The method of claim 1 further comprising:
performing an optical character recognition on the digital image.

6. The method of claim 1 further comprising:
wherein the portion of the book is a cover.

7. The method of claim 1 further comprising:
wherein the portion of the book is an international standard book number (ISBN).

8. The method of claim 1 further comprising:
wherein the portion of the book is a page of the book.

9. A system comprising:
a digital image receiver to receive a digital image of a portion of a book;
a book identifying module to determine a unique identification of the book from the digital image;
a search module to search for an eBook version of the book; and
a purchase module to purchase the eBook and add the eBook to a buyer's e-library.

10. The system of claim 9 further comprising:
automatically downloading the eBook to a buyer's computer.

11. The system of claim 9 wherein the digital image is a photograph of a hard copy of the book.

12. The system of claim 9 wherein the digital image is a photograph of an electronic copy of the book.

13. The system of claim 9 wherein the book identifying module utilizes an optical character recognition on the digital image to determine the unique identification of the book.

14. The system of claim 9 wherein the digital image of the portion of the book is selected from the group consisting of: a cover and a page of the book.

15. The system of claim 9 wherein the digital image of the portion is selected from the group consisting of: an international standard book number (ISBN), a barcode, a matrix barcode, a universal product code (UPC), and a uniform resource locator (URL).

16. A computer implemented method for utilizing an image for facilitating an eBook transaction, said method comprising:
receiving a digital image of a portion of a book;
utilizing the digital image to determine a unique identification of the book;
utilizing the unique identification of the book to find an eBook version;
providing an offer to sell an eBook version of the book;
receiving an acceptance to purchase the eBook; and
providing the eBook to a buyer's e-library.

17. The method of claim 16 further comprising:
receiving the digital image of the portion of the book from a photograph of a hard copy of the book.

18. The method of claim 16 further comprising:
receiving the digital image of the portion of the book from a photograph of an electronic copy of the book.

19. The method of claim 16 further comprising:
performing an optical character recognition on the digital image of the portion of the book.

20. The method of claim 16 wherein the portion of the book is selected from the group consisting of: a cover, an international standard book number (ISBN), a page of the book, a barcode, a matrix barcode, a universal product code (UPC), and a uniform resource locator (URL).
